(19) United States
(12) Patent Application Publication
(10) Pub. No.: US 2025/0162336 A1
(43) Pub. Date: May 22, 2025

(54) DRYING DEVICE, DRYING SYSTEM, AND IMAGE FORMING APPARATUS

(71) Applicant: Koki DAI, KANAGAWA (JP)

(72) Inventor: Koki DAI, KANAGAWA (JP)

(21) Appl. No.: 18/953,167

(22) Filed: Nov. 20, 2024

(30) Foreign Application Priority Data
Nov. 21, 2023 (JP) 2023-197299

(51) Int. Cl. B41J 29/377; B41J 11/00; G03G 21/20

(52) U.S. Cl. CPC B41J 29/377; B41J 11/0015; G03G 21/206

(57) ABSTRACT

A drying device includes a housing in which an exhaust opening and a connection opening are arranged, a conveyor in the housing to convey a recording medium along a conveyance path, a heater in the housing to heat the recording medium on the conveyance path, a connection terminal to connect a line routed from an outside of the housing, a humidity sensor to detect a humidity inside the housing, an airflow fan to move air inside the housing to generate an airflow passing the connection terminal, an exhaust fan to discharge air inside the housing to an outside of the housing through the exhaust opening, a duct fan to discharge air inside the housing through an exhaust duct connected to the connection opening, and processing circuitry to control operations of the airflow fan, the exhaust fan, and the duct fan based on a detected humidity by the humidity sensor.

### CROSS-REFERENCE TO RELATED APPLICATION

This patent application is based on and claims priority pursuant to 35 U.S.C. § 119 (a) to Japanese Patent Application No. 2023-197299, filed on Nov. 21, 2023, in the Japan Patent Office, the entire disclosure of which is hereby incorporated by reference herein.

### BACKGROUND

### Technical Field

Embodiments of this disclosure relate to a drying device, a drying system, and an image forming apparatus.

### Related Art

In an image forming apparatus, for example, an inkjet image forming apparatus and an electrophotographic image forming apparatus, excess humidity inside a housing is not preferred as the excess humidity causes dew condensation. To reduce occurrences of dew condensation, an airflow is generated in an area where the dew condensation tends to occur, and excess moisture inside the housing is discharged to the outside of the housing. For example, an image forming apparatus includes a cartridge fan and a discharge path fan. The cartridge fan prevents dew condensation from occurring on a laser beam emitting surface (a dustproof glass) of a scanner unit, and the discharge path fan discharges steam generated in a fixing device to the outside of a housing.

### SUMMARY

The present disclosure described herein provides a drying device that includes a housing, a conveyor, a heater, a connection terminal, a humidity sensor, an airflow fan, an exhaust fan, a duct fan, and processing circuitry. An exhaust opening and a connection opening are arranged in the housing. The conveyor is housed in the housing to convey a recording medium along a conveyance path. The heater is housed in the housing to heat the recording medium on the conveyance path. The connection terminal connects a line routed from an outside of the housing. The line is connected to the connection terminal inside the housing. The humidity sensor detects a humidity inside the housing. The airflow fan moves air inside the housing to generate an airflow passing the connection terminal. The exhaust fan discharges air inside the housing to an outside of the housing through the exhaust opening. The duct fan discharges air inside the housing through an exhaust duct connected to the connection opening. The processing circuitry controls operations of the airflow fan, the exhaust fan, and the duct fan based on a detected humidity that is detected by the humidity sensor.

The present disclosure described herein also provides a drying system that includes a first drying device and a second drying device, a duct fan, processing circuitry, a first exhaust duct, a second exhaust duct, and a common exhaust duct. Each of the first drying device and the second drying device includes a housing, a conveyor, a heater, a connection terminal, a humidity sensor, an airflow fan, and an exhaust fan. In the housing, an exhaust opening and a connection opening are arranged. The conveyor is housed in the housing to convey a recording medium along a conveyance path. The heater is housed in the housing to heat the recording medium on the conveyance path. The connection terminal connects a line routed from an outside of the housing. The line is connected to the connection terminal inside the housing. The humidity sensor detects a humidity inside the housing. The airflow fan moves air inside the housing to generate an airflow passing the connection terminal. The exhaust fan discharges air inside the housing to an outside of the housing through the exhaust opening. The duct fan discharges air inside the housing. The processing circuitry controls operations of the airflow fan and the exhaust fan of the first drying device and the duct fan based on a detected humidity that is detected by the humidity sensor of the first drying device, and controls operations of the airflow fan and the exhaust fan of the second drying device and the duct fan based on a detected humidity that is detected by the humidity sensor of the second drying device. The first exhaust duct has an upstream end connected to the connection opening of the first drying device. The second exhaust duct has an upstream end connected to the connection opening of the second drying device. The common exhaust duct has an upstream end communicating with each of a downstream end of the first exhaust duct and a downstream end of the second exhaust duct. The duct fan is disposed in the common exhaust duct.

The present disclosure described herein further provides an image forming apparatus that includes an image forming device to form an image on a recording medium and the drying device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall configuration of an image forming apparatus according to one embodiment of the present disclosure;

FIG. 2 is a schematic diagram illustrating a configuration of a drying device;

FIG. 3 is a block diagram illustrating a configuration of the image forming apparatus;

FIG. 4 is a flowchart illustrating each of processes performed by the image forming apparatus;

FIG. 5 is a schematic diagram illustrating a state in which all of fans in the drying device are stopped;

FIG. 6 is a schematic diagram illustrating a state in which an airflow fan is operated and other fans are stopped in the drying device;

FIG. 7 is a schematic diagram illustrating a state in which the airflow fan and an exhaust fan are operated and a duct fan is stopped in the drying device;

FIG. 8 is a schematic diagram illustrating a state in which all of the fans in the drying device are operated;

FIG. 9 is a flowchart illustrating control of a drying process (a drying process subsequent to pre-processing, a drying process subsequent to post-processing) by a controller;

FIG. 10 is a schematic diagram illustrating a state in which the airflow fan and the duct fan are operated and the exhaust fan is stopped in the drying device;

FIG. 11 is a flowchart illustrating other control performed by the controller in the drying process;

FIG. 12 is a schematic diagram illustrating a configuration of a drying device including a plurality of electrical units according to a second embodiment;

FIG. 13 is a schematic diagram illustrating a configuration in which a duct fan is disposed in a common exhaust duct according to a third embodiment;

FIG. 14 is a schematic diagram illustrating a configuration in which a duct fan is disposed in a third common exhaust duct according to a fourth embodiment; and

FIG. 15 is a block diagram illustrating a configuration of a drying device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Brief Description of Image Forming Apparatus 1

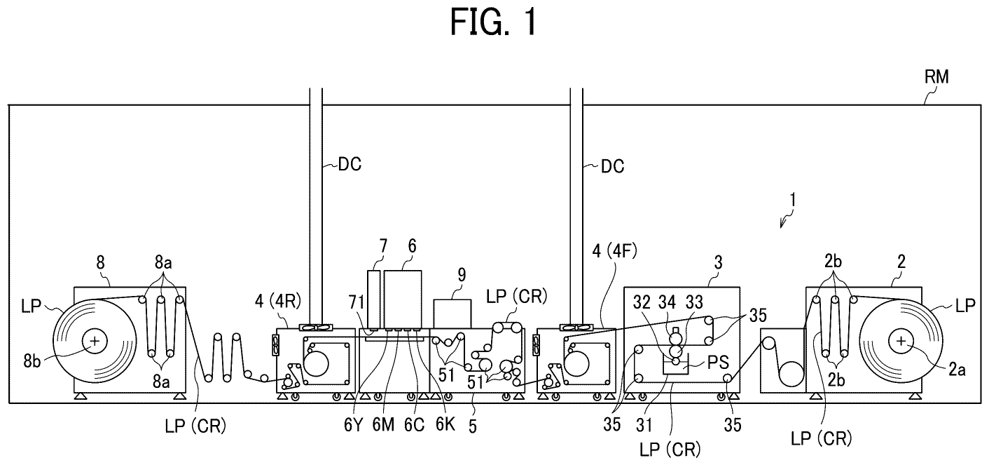

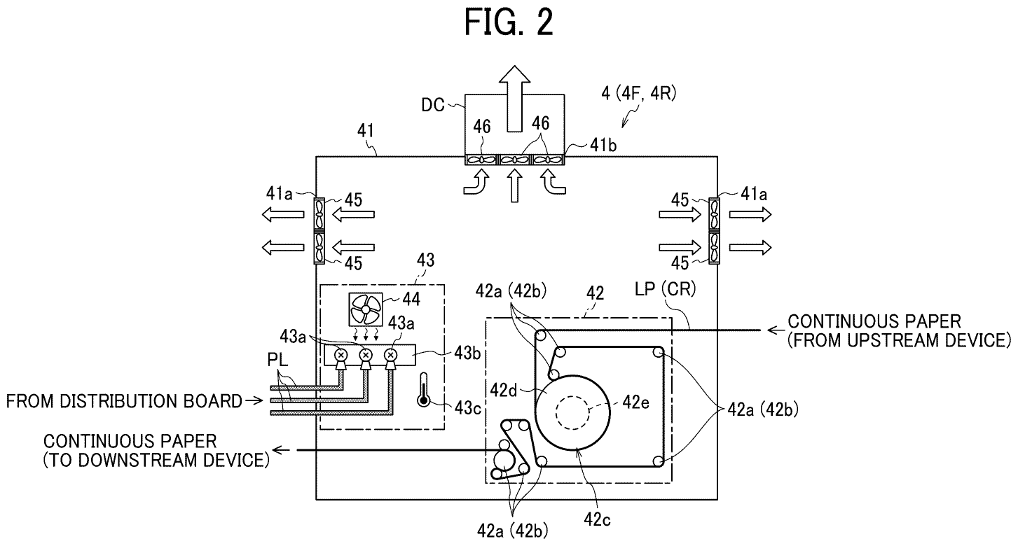

FIG. 1 is a schematic diagram illustrating an overall configuration of an image forming apparatus 1 (including a drying device) according to one embodiment of the present disclosure. First, the image forming apparatus 1 is briefly described with reference to FIG. 1. The description is hereinafter given using an industrial image forming apparatus as an example of the image forming apparatus 1. The industrial image forming apparatus forms an image on continuous paper LP (a recording medium) such as a continuous form. However, the present disclosure can be applied to another type of image forming apparatus. For example, the present disclosure can even be applied to a consumer image forming apparatus as long as an amount of liquid to evaporate from a recording medium by the consumer image forming apparatus is greater than that by a widely-used image forming apparatus, and the air inside a housing 41 is discharged via an exhaust duct DC (see FIG. 2). Types, combinations, shapes, and relative arrangements of components described in the present disclosure are merely examples and a scope of the present disclosure is not limited thereto unless otherwise noted.

The image forming apparatus 1 illustrated in FIG. 1 includes a loading unit 2, a pre-processing unit 3, a pre-processing drying unit 4F, a guide 5, an image forming unit 6, a post-processing unit 7, a post-processing drying unit 4R, an ejection unit 8, and a controller 9 (circuitry). Continuous paper LP wound in a roll shape prior to image formation is loaded into the loading unit 2, and the loading unit 2 sequentially feeds the loaded continuous paper LP. The pre-processing unit 3 performs a pre-process on the continuous paper LP fed from the loading unit 2. The pre-processing drying unit 4F dries the continuous paper LP on which the pre-processing has been performed. The guide 5 guides the continuous paper LP discharged from the pre-processing drying unit 4F to a downstream side along a conveyance direction. The image forming unit 6 (an image forming device) forms an image on the continuous paper LP discharged from the guide 5. The post-processing unit 7 performs a post-process on the continuous paper LP on which the image has been formed. The post-processing drying unit 4R dries the continuous paper LP on which the post-process has been performed. The ejection unit 8 winds the continuous paper LP discharged from the post-processing drying unit 4R in a roll shape, and ejects the continuous paper LP in the roll shape. The controller 9 controls each unit. In the image forming apparatus 1 illustrated in FIG. 1, a pair of the pre-processing drying unit 4F and the controller 9 and a pair of the post-processing drying unit 4R and the controller 9 each correspond to a drying device according to one embodiment of the present disclosure.

In the present embodiment, since the pre-processing drying unit 4F and the post-processing drying unit 4R have the same configuration, the pre-processing drying unit 4F and the post-processing drying unit 4R are collectively called a drying unit 4 for the sake of description. FIG. 2 is a schematic diagram illustrating a configuration of the drying unit 4. As illustrated in FIG. 2, the drying unit 4 includes the housing 41, a conveyance unit 42b, a heat roller 42c (a heater), a connection terminal 43a, a humidity sensor 43c, and a plurality of types of fans 44, 45, and 46. The housing 41 has an exhaust opening 41a and a connection opening 41b. The conveyance unit 42b (an example of a conveyor) is housed in the housing 41, and conveys continuous paper LP along a conveyance path CR. The heat roller 42c is housed in the housing 41, and heats the continuous paper LP on the conveyance path CR. The connection terminal 43a connects a line PL that is for the heat roller 42c and routed from an outside of the housing 41. The line PL is connected inside the housing 41. The humidity sensor 43c detects a humidity inside the housing 41. The fans 44, 45, and 46 are disposed inside the housing 41.

As for the plurality of types of fans 44, 45, and 46 in the drying unit 4, for example, the fan 44 is an airflow fan (the fan 44 is hereinafter also referred to as an airflow fan 44), the fan 45 is an exhaust fan (the fan 45 is hereinafter also referred to as an exhaust fan 45), and the fan 46 is a duct fan (the fan 46 is hereinafter also referred to as a duct fan 46). The airflow fan 44 moves the air inside the housing 41 such that an airflow passing the connection terminal 43a is generated. The exhaust fan 45 discharges the air inside the housing 41 to the outside of the housing 41 via the exhaust opening 41a. The duct fan 46 discharges the air inside the housing 41 to the outside of a room RM (see FIG. 1) or the outside of a building via an exhaust duct DC connected to the connection opening 41b. However, the drying unit 4 may include other fans. The controller 9 (see FIG. 1) controls operations of the airflow fan 44, the exhaust fan 45, and the duct fan 46 base on a humidity detected by the humidity sensor 43c. Accordingly, an airflow passing the connection terminal 43a is generated inside the housing 41, and a discharge destination of the air inside the housing 41 can be selected from either the outside of the housing 41 or the exhaust duct DC (i.e., selected from either the room RM or the outside of the room RM). As a result, a humidity inside the housing 41 can be appropriately managed.

### Details of Image Forming Apparatus 1

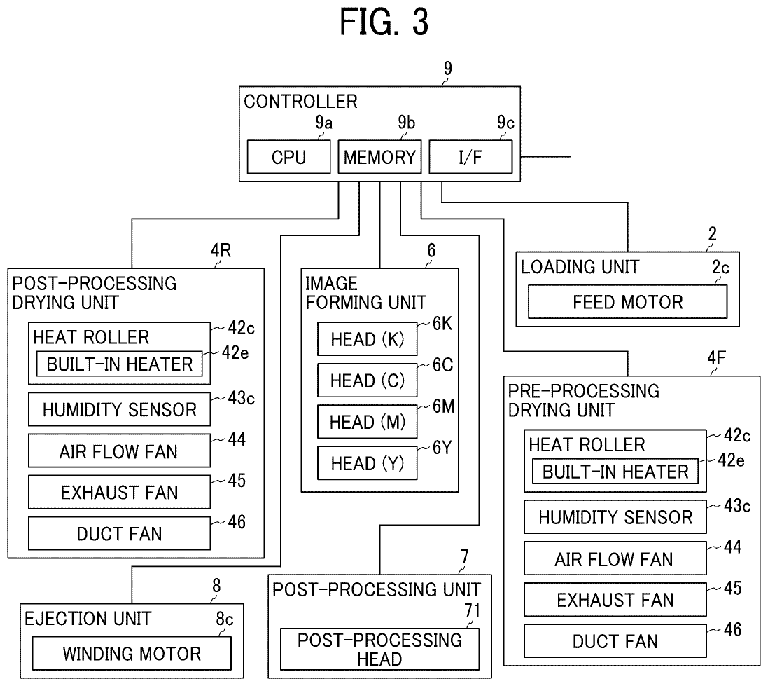

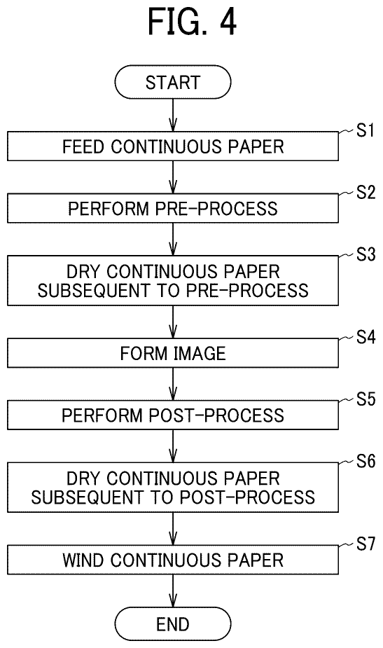

A configuration of the image forming apparatus 1 is described with reference to FIGS. 1 through 4. FIG. 3 is a block diagram illustrating a configuration of the image forming apparatus 1, and FIG. 4 is a flowchart illustrating each of processes performed by the image forming apparatus 1. As illustrated in FIG. 3, the controller 9 includes a central processing unit (CPU) 9a, a memory 9b in which an operation program of the CPU 9a and various pieces of information are stored, and an interface (I/F) 9c for communication. The controller 9 can control each of units included in the loading unit 2, the pre-processing drying unit 4F, the image forming unit 6, the post-processing unit 7, the post-processing drying unit 4R, and the ejection unit 8.

The loading unit 2 illustrated in FIG. 1 includes a feed unit 2a that holds continuous paper LP wound in a roll shape in a state in which the continuous paper LP can be fed, and a guide roller 2b that guides the continuous paper LP fed from the rolled portion. The feed unit 2a is a cylindrical member. For example, a center void of the continuous paper LP wound in a roll shape is inserted into the feed unit 2a. The feed unit 2a is rotated by a feed motor 2c illustrated in FIG. 3. An operation of the feed motor 2c is controlled by the controller 9. A plurality of guide rollers 2b is disposed on the conveyance path CR of the continuous paper LP. The plurality of guide rollers 2b guides the continuous paper LP to move the continuous paper LP along the conveyance path CR while controlling slack in the continuous paper LP such that the continuous paper LP is not wrinkled. The continuous paper LP is a type of recording medium. In the present embodiment, although the continuous paper LP is, for example, long paper in which tearable perforations are formed a certain distance apart, the continuous paper LP is not limited thereto.

The pre-processing unit 3 receives the continuous paper LP fed from the loading unit 2, and performs a pre-process on the continuous paper LP. In the pre-process, the pre-processing unit 3 applies pre-processing solution PS to a surface of the continuous paper LP. The pre-processing unit 3 of the present embodiment includes a container 31 in which, for example, the pre-processing solution PS is reserved, a thinning roller 32 disposed inside the container 31, an application roller 33 that contacts the thinning roller 32 from above, a platen roller 34 that contacts the application roller 33 from above, and a plurality of guide rollers 35 that guide the continuous paper LP in the pre-processing unit 3. The continuous paper LP is guided along the conveyance path CR by the plurality of guide rollers 35. At an intermediate position of the conveyance path CR, the continuous paper LP is nipped (nipped in a conveyable manner) between the application roller 33 and the platen roller 34 that are rotatable about axes. The pre-processing solution PS is applied to a surface of the continuous paper LP by the application roller 33. For example, the pre-processing solution PS is transferred from a surface of the thinning roller 32 to a surface of the application roller 33, and is then applied from the surface of the application roller 33 to a surface of the continuous paper LP. The applied pre-processing solution PS remains on the surface of the continuous paper LP. In the present embodiment, an amount of the pre-processing solution PS to be applied to the continuous paper LP is determined depending on, for example, a pressing force between the platen roller 34 and the application roller 33.

The pre-processing drying unit 4F dries the pre-processing solution PS applied on the surface of the continuous paper LP. A detailed description of the pre-processing drying unit 4F is given below. The guide 5 is disposed between the pre-processing drying unit 4F and the image forming unit 6. The guide 5 guides the continuous paper LP discharged from the pre-processing drying unit 4F toward the image forming unit 6 on a downstream side in the conveyance direction while controlling slack in the continuous paper LP. Thus, the guide 5 includes a plurality of guide rollers 51. The continuous paper LP radiates heat while passing the guide 5, so that temperature of the continuous paper LP is adjusted to, for example, ambient temperature (temperature of the room RM in which the image forming apparatus 1 is placed).

The image forming unit 6 forms an image on a surface of the continuous paper LP discharged by the guide 5. The image forming unit 6 of the present embodiment employs an inkjet method. For example, the image forming unit 6, as illustrated in FIGS. 1 and 3, includes heads 6K, 6C, 6M, and 6Y that respectively discharge black, cyan, magenta, and yellow ink. Each of the heads 6K, 6C, 6M, and 6Y includes a plurality of nozzles that are spaced a certain distance apart along, for example, a width direction of the continuous paper LP (a direction perpendicular to the conveyance direction), and can discharge ink droplets from each of the nozzles. In the present embodiment, for example, the heads 6K, 6C, 6M, and 6Y are arranged in order from an upstream side in the conveyance direction of the continuous paper LP.

The post-processing unit 7 performs a post-process in which post-processing solution is applied to a surface of the continuous paper LP discharged from the image forming unit 6. The post-processing unit 7 of the present embodiment includes, for example, a post-processing head 71 that discharges post-processing solution. The post-processing head 71 includes, for example, a plurality of nozzles spaced a certain distance a part along the width direction of the continuous paper LP, and discharges the post processing solution in drops from each of the nozzles. For example, the post-processing head 71 selectively discharges the post processing solution to an area with an image formed on a surface of the continuous paper LP, or discharges the post processing solution to the entire surface of the continuous paper LP. A components of the post processing solution which has adhered to the surface of the continuous paper LP is fixed to the surface of the continuous paper LP by dryness (evaporation of solvent), and a post-processing layer is formed. The formation of the post processing layer enhances rub-fastness, glossiness, and storage stability (e.g., water resistance, light resistance, and gas resistance) of the surface of the continuous paper LP.

The post-processing drying unit 4R dries the post-processing solution applied to the surface of the continuous paper LP. A detailed description of the post-processing drying unit 4R is given below. The ejection unit 8 includes a guide roller 8a that guides the continuous paper LP discharged from the post-processing drying unit 4R, and a winding unit 8b by which the continuous paper LP guided by the guide roller 8a is wound in a roll shape. A plurality of guide rollers 8a is disposed on the conveyance path CR of the continuous paper LP. The guide rollers 8a guide the continuous paper LP to move along the conveyance path CR while controlling slack in the continuous paper LP. The continuous paper LP discharged from the post-processing drying unit 4R radiates heat while moving along the conveyance path CR, and temperature of the continuous paper LP is adjusted to, for example, ambient temperature. The winding unit 8b is, for example, a cylindrical member around which the continuous paper LP is wound, and is rotated by a winding motor 8c illustrated in FIG. 3. An operation of the winding motor 8c is controlled by the controller 9.

After the continuous paper LP wound in a roll shape around the winding unit 8b is cut from the continuous paper LP in a position upstream from the continuous paper LP in the roll shape, the resultant continuous paper LP is removed from the winding unit 8b and ejected from the ejection unit 8. Subsequently, a cut end portion (a downstream end portion) of the continuous paper LP is wound around the winding unit 8b, and image formation on the continuous paper LP continues.

In the image forming apparatus 1 with such configurations, processes S1 through S7 illustrated in FIG. 4 are performed in order, thereby forming an image on a surface of the continuous paper LP. In step S1, the loading unit 2 feeds continuous paper LP. In step S2, the pre-processing unit 3 performs a pre-process on the continuous paper LP. In step S3, the pre-processing drying unit 4F dries the continuous paper LP subsequent to the pre-process. In step S4, the image forming unit 6 forms an image on the continuous paper LP. In step S5, the post-processing unit 7 perform a post-process on the continuous paper LP. In step S6, the post-processing drying unit 4R dries the continuous paper LP subsequent to the post-process. In step S7, the ejection unit 8 winds the continuous paper LP.

### Details of Drying Unit 4

Next, the drying unit 4 (the pre-processing drying unit 4F, the post-processing drying unit 4R) is described in detail. As illustrated in FIG. 2, the housing 41 in the drying unit 4 includes the exhaust opening 41a and the connection opening 41b. In the exhaust opening 41a, the exhaust fan 45 for discharging the air inside the housing 41 to the outside of the housing 41 is arranged. In the connection opening 41b, an upstream end of the exhaust duct DC for discharging the air inside the housing 41 to the outside of the building in which the image forming apparatus 1 is placed is connected, and the duct fan 46 for discharging the air inside the housing 41 toward the exhaust duct DC is arranged.

In the housing 41, a heating unit 42 that includes the conveyance unit 42b including a plurality of guide rollers 42a is arranged. The plurality of guide rollers 42a guides the continuous paper LP along a predetermined conveyance path CR. The guide roller 42a is, for example, a cylindrical member made of metal. The heat roller 42c is disposed at an intermediate position of the conveyance path CR. The heat roller 42c includes, for example, a cylindrical member 42d made of metal and a built-in heater 42e disposed inside the cylindrical member 42d. The continuous paper LP to be conveyed along the conveyance path CR contacts an outer circumferential surface of the cylindrical member 42d. As illustrated in FIG. 3, the controller 9 controls energization of the heat roller 42c (the built-in heater 42e). When the built-in heater 42e generates heat with the energization, the heat of the built-in heater 42e is transferred to an outer circumferential surface of the cylindrical member 42d, and a temperature of the outer circumferential surface rises. The continuous paper LP is heated by contacting the outer circumferential surface of the cylindrical member 42d in the course of conveyance of the continuous paper LP along the conveyance path CR. When the continuous paper LP is heated, liquid (e.g., solvent of the pre-processing solution PS and solvent of the post-processing solution) retained by the continuous paper LP evaporates. A humidity inside the housing 41 rises with the evaporation of the liquid.

In addition, an electrical unit 43 is disposed inside the housing 41. The electrical unit 43 includes a terminal board 43b on which a plurality of connection terminals 43a is arranged, the humidity sensor 43c which detects a humidity inside the housing 41 (e.g., a humidity in the vicinity of the connection terminal 43a), and the airflow fan 44 which moves the air inside the housing 41 such that an airflow passing the connection terminal 43a is generated. The generation of the airflow passing the connection terminal 43a prevents an unfavorable situation in which water droplets due to dew condensation adhere to the connection terminal 43a. Each of the plurality of connection terminals 43a is connected to a line PL for the heat roller 42c. The line PL for the heat roller 42c is routed from, for example, an electric switchboard outside the housing 41. An example of the line PL for the heat roller 42c includes a line that can carry an electric current necessary for operation of the built-in heater 42e. The connection terminal 43a is not limited to a terminal that connects the line PL for the heat roller 42c as long as a line routed from the outside of the housing 41 can be connected. As illustrated in FIG. 3, the humidity sensor 43c is electrically connected to the controller 9, and a detection signal from the humidity sensor 43c is input to the controller 9. The controller 9 can detect a humidity inside the housing 41, for example, a humidity in the vicinity of the electrical unit 43, based on the detection signal from the humidity sensor 43c.

Each of Fans 44, 45, and 46 of Drying Unit 4

The drying unit 4 includes the airflow fan 44, the exhaust fan 45, and the duct fan 46 as described above. Since the uses of the fans 44, 45, and 46 are different, blowability of each of the fans 44, 45, and 46 differs. For example, since the airflow fan 44 is used to generate an airflow passing the connection terminal 43a, a fan having a lowest blowability is used for the airflow fan 44. Accordingly, a fan that consumes less power than the exhaust fan 45 and the duct fan 46 and generates operating noise quieter than that generated by the exhaust fan 45 and the duct fan 46 can be used for the airflow fan 44. Since the exhaust fan 45 discharges the air inside the housing 41 to the outside of the housing 41 (e.g., the air is discharged to the inside of the room RM in which the image forming apparatus 1 is placed) via the exhaust opening 41a, a fan having a moderate blowability is used for the exhaust fan 45. Accordingly, a fan that consumes less power than the duct fan 46 and generates operating noise quieter than that generated by the duct fan 46 can be used for the exhaust fan 45. Since the duct fan 46 discharges the air inside the housing 41 to the outside of the housing 41 (e.g., the air is discharged to the outside of the building including the room RM) via the exhaust duct DC, a fan having a highest blowability is used for the duct fan 46. Accordingly, a fan that consumes more power than the airflow fan 44 and the exhaust fan 45 and generates operating noise louder than that generated by the airflow fan 44 and the exhaust fan 45 can be used for the duct fan 46.

Particularly, the drying unit 4 includes one airflow fan 44, and the airflow fan 44 has a power consumption of 13.4 W and a sound pressure level of 40 dB. The drying unit 4 includes thirty-two exhaust fans 45, and the exhaust fans 45 have an overall power consumption of 430.1 W and a sound pressure level of 55 dB. The drying unit 4 includes one-hundred-twenty-eight duct fans 46, and the duct fans 46 have an overall power consumption of 172 W and a sound pressure level of 61 dB. Thus, as far as suppression of power consumption and operating noise in each of the fans 44, 45, and 46 is concerned, an operating ratio of the airflow fan 44 is desirably increased as high as possible, whereas an operating ratio of the duct fan 46 is desirably reduced as low as possible.

### Example of Operation of Drying Unit 4

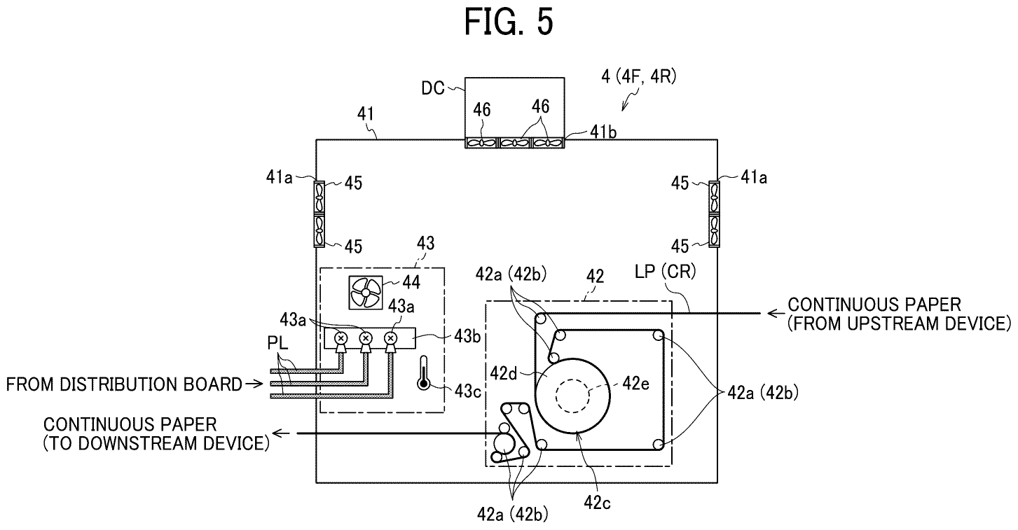

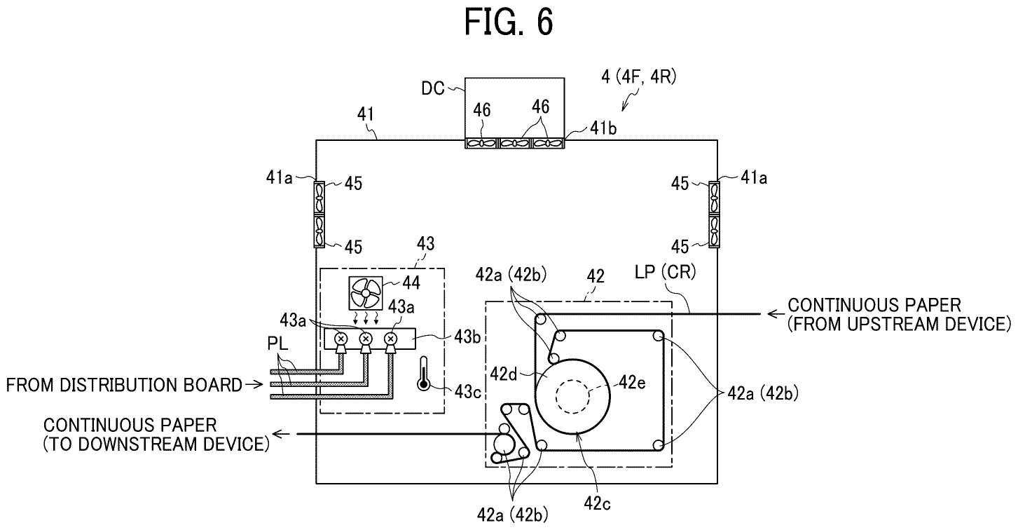

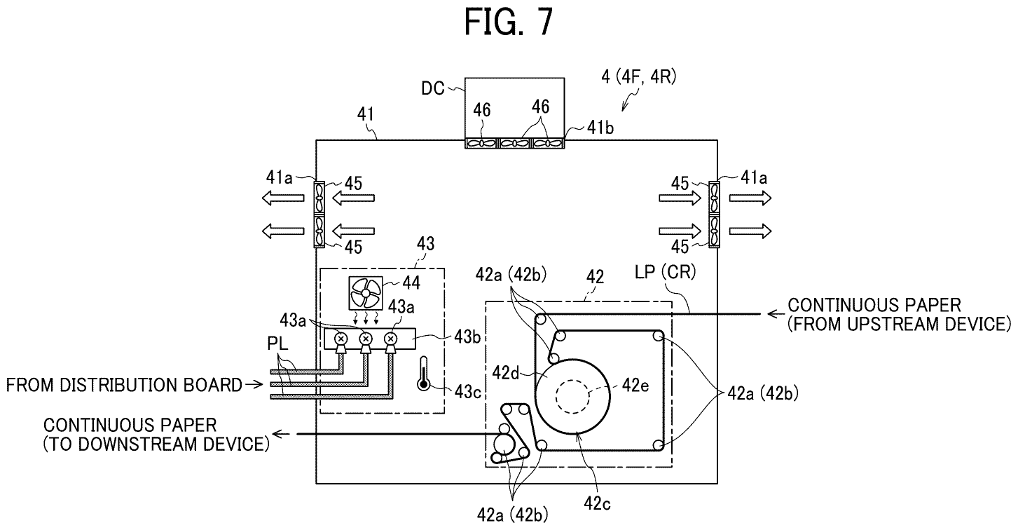

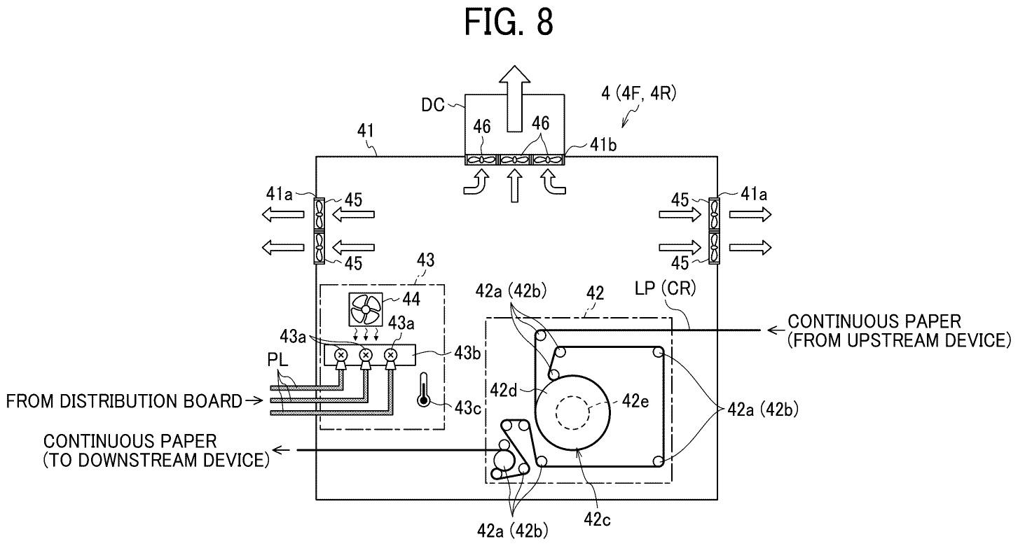

Hereinafter, an example of an operation of the drying unit 4 is described. FIG. 5 is a schematic diagram illustrating a state in which all of the fans 44, 45, and 46 of the drying unit 4 are stopped. FIG. 6 is a schematic diagram illustrating a state in which the airflow fan 44 of the drying unit 4 is operated and the other fans 45 and 46 are stopped. FIG. 7 is a schematic diagram illustrating a state in which the airflow fan 44 and the exhaust fan 45 of the drying unit 4 are operated and the duct fan 46 is stopped. FIG. 8 is a schematic diagram illustrating a state in which all of the fans 44, 45, and 46 of the drying unit 4 are operated.

The drying process (each of steps S3 and S6 in FIG. 4) is performed during a period in which the continuous paper LP is conveyed, whereas the drying process is not performed during a period in which conveyance of the continuous paper LP is stopped. In the drying process, the controller 9 periodically acquires a detection signal from the humidity sensor 43c, and determines whether a detected humidity based on the detection signal exceeds a humidity threshold value. The threshold value is defined in, for example, a humidity that can cause dew condensation to occur inside the housing 41. If the detected humidity does not exceed the humidity threshold value, the controller 9 stops the airflow fan 44, the exhaust fan 45, and the duct fan 46 as illustrated in FIG. 5.

If the detected humidity exceeds the humidity threshold value in a state in which the airflow fan 44, the exhaust fan 45, and the duct fan 46 are stopped, the controller 9 operates the airflow fan 44 only as illustrated in FIG. 6. Such operation of the airflow fan 44 generates an airflow passing the connection terminal 43a, thereby preventing an unfavorable situation in which water droplets due to dew condensation adhere to the connection terminal 43a. The controller 9 periodically acquires a detection signal from the humidity sensor 43c even after the operation of the airflow fan 44 begins, and determines whether a detected humidity exceeds the humidity threshold value.

If the detected humidity exceeds the humidity threshold value even after a prescribed time (a first prescribed time) has elapsed from the beginning of the operation of the airflow fan 44, the controller 9 operates the exhaust fan 45 in addition to the airflow fan 44 as illustrated in FIG. 7. The first prescribed time is determined appropriately. The operation of the exhaust fan 45 discharges the air inside the housing 41 to the outside of the housing 41 (within the room RM) via the exhaust opening 41a. Since the air inside the housing 41 has moisture, the discharge of the air to the outside of the housing 41 can lower the humidity inside the housing 41. Hence, dew condensation can be prevented from occurring inside the housing 41. The controller 9 periodically acquires a detection signal from the humidity sensor 43c even after the operation of the exhaust fan 45 begins, and determines whether a detected humidity based on the detection signal exceeds the humidity threshold value.

If the detected humidity exceeds the humidity threshold value even after a prescribed time (a second prescribed time) has elapsed from the beginning of the operation of the exhaust fan 45, the controller 9 operates the duct fan 46 in addition to the airflow fan 44 and the exhaust fan 45 as illustrated in FIG. 8. The second prescribed time is determined appropriately. With the operation of the duct fan 46, the air inside the housing 41 is also discharged to the outside of the housing 41 (the outside of the room RM, for example, the outside of the building in which the image forming apparatus 1 is placed) via the exhaust duct DC. That is, one part of the air inside the housing 41 is discharged to the inside of the room RM via the exhaust opening 41a, and the other part of the air is discharged to the outside of the building via the exhaust duct DC. An amount of the air to be discharged via the exhaust duct DC is greater than that via the exhaust opening 41a. Since the duct fan 46 and the exhaust fan 45 are operated to discharge the air inside the housing 41, a humidity inside the housing 41 can be lowered quickly.

The controller 9 periodically acquires a detection signal from the humidity sensor 43c even after the operation of the duct fan 46 begins, and determines whether a detected humidity based on the detection signal exceeds the humidity threshold value. The controller 9 operates the airflow fan 44, the exhaust fan 45, and the duct fan 46 until a detected humidity reaches the humidity threshold value or less. If the detected humidity reaches the humidity threshold value or less, the controller 9 stops all of the fans 44, 45, and 46. When all of the fans 44, 45, and 46 are stopped, the fans 44, 45, and 46 return to the state illustrated in FIG. 5.

According to the image forming apparatus 1 of the present embodiment, therefore, in each of the drying processes S3 and S6, an operating ratio of the airflow fan 44 can be increased, and an operating ratio of the duct fan 46 can be reduced. Since the airflow fan 44 consumes less power than the exhaust fan 45 and the duct fan 46 and generates operating noise quieter than that generated by the exhaust fan 45 and the duct fan 46, the airflow fan 44 is operated, and the other fans 45 and 46 are stopped. Thus, adhesion of water droplets to the connection terminal 43a can be prevented, and power consumption and operating noise can be suppressed. The exhaust fan 45 consumes less power than the duct fan 46, and generates operating noise quieter than that generated by the duct fan 46. Thus, the exhaust fan 45 is operated, and the duct fan 46 is stopped, so that humidity inside the housing 41 can be lowered, and power consumption and operating noise can be suppressed in comparison with a case in which the duct fan 46 is operated. The duct fan 46 has higher dischargeability than the exhaust fan 45, and thus humidity inside the housing 41 can be lowered quickly. Moreover, since the exhaust duct DC discharges the air toward the outside of the building, the use of the exhaust duct DC can suppress a rise in humidity of the room RM.

### Example of Control

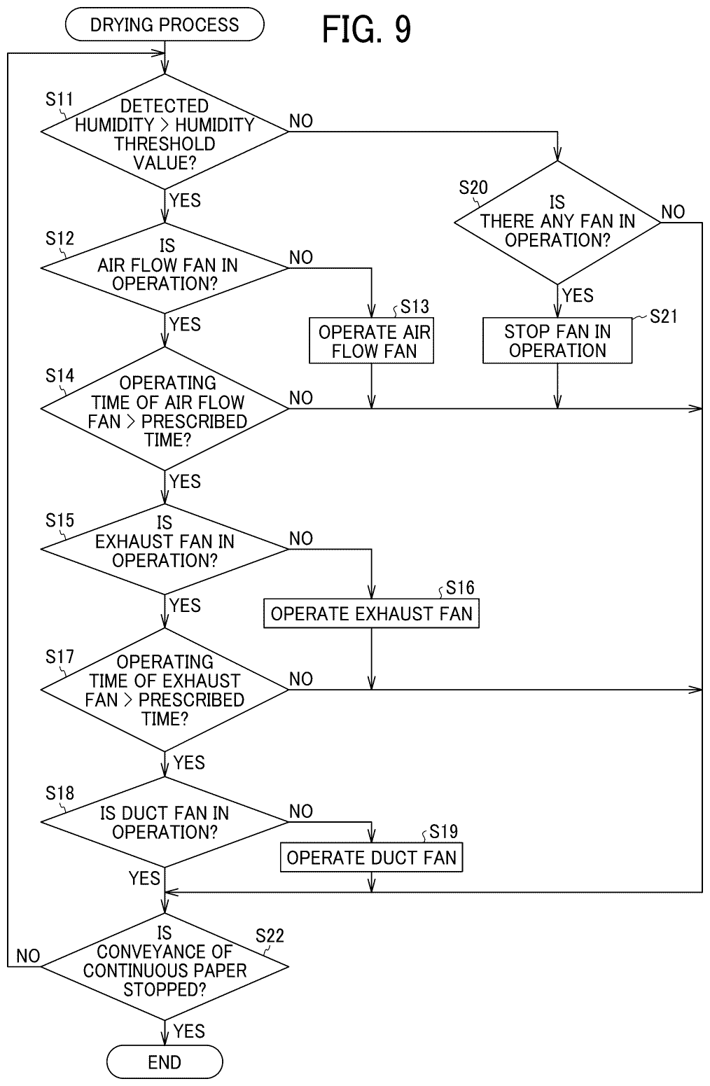

Next, the control performed by the controller 9 in each of the drying processes S3 and S6 is described. FIG. 9 is a flowchart illustrating the control performed by the controller 9 in the drying process. The controller 9 energizes the heat roller 42c (the built-in heater 42e) before the drying process is started, and adjusts a temperature of an outer circumferential surface of the heat roller 42c to a prescribed temperature. The drying process is started after the outer circumferential surface of the heat roller 42c is adjusted to the prescribed temperature. In step S11, when the drying process is started, the controller 9 acquires a detected humidity based on a detection signal from the humidity sensor 43c, and determines whether the detected humidity exceeds a humidity threshold value. If the controller 9 determines that the detected humidity exceeds the humidity threshold value (YES in step S11), the process proceeds to step S12. In step S12, the controller 9 determines whether the airflow fan 44 is in operation. If the airflow fan 44 is not in operation (NO in step S12), the process proceeds to step S13. In step S13, the controller 9 operates the airflow fan 44. Subsequently, the process proceeds to step S22.

On the other hand, if the airflow fan 44 is in operation (YES in step S12), the process proceeds to step S14. In step S14, the controller 9 determines whether an operating time of the airflow fan 44 exceeds a prescribed time (a first prescribed time). If the operating time of the airflow fan 44 does not exceed the prescribed time (NO in step S14), the process proceeds to step S22. On the other hand, if the operating time of the airflow fan 44 exceeds the prescribed time (YES in step S14), the process proceeds to step S15. In step S15, the controller 9 determines whether the exhaust fan 45 is in operation. If the exhaust fan 45 is not in operation (NO in step S15), the process proceeds to step S16. In step S16, the controller 9 operates the exhaust fan 45. Subsequently, the process proceeds to step S22.

If the exhaust fan 45 is in operation (YES in step S15), the process proceeds to step S17. In step S17, the controller 9 determines whether an operating time of the exhaust fan 45 exceeds a prescribed time (a second prescribed time). If the operating time of the exhaust fan 45 does not exceed the prescribed time (NO in step S17), the process proceeds to step S22. On the other hand, if the operating time of the exhaust fan 45 exceeds the prescribed time (YES in step S17), the process proceeds to step S18. In step S18, the controller 9 determines whether the duct fan 46 is in operation. If the duct fan 46 is not in operation (NO in step S18), the process proceeds to step S19. In step S19, the controller 9 operates the duct fan 46. Subsequently, the process proceeds to step S22. On the other hand, if the duct fan 46 is in operation (YES in step S18), the process proceeds to step S22.

If the detected humidity does not exceed the humidity threshold value (NO in step S11), the process proceeds to step S20. In step S20, the controller 9 determines whether there is a fun in operation. If there is no fan in operation (NO in step S20), the process proceeds to step S22. If there is a fan that is in operation (YES in step S20), the process proceeds to step S21. Then, in step S21, the controller 9 stops the fun in operation. Subsequently, the process proceeds to step S22. In step S22, the controller 9 determines whether conveyance of the continuous paper LP is stopped. If the conveyance of the continuous paper LP is stopped (YES in step S22), a series of steps in the drying process ends. If the conveyance of the continuous paper LP is not stopped (NO in step S22), the process proceeds to step S11 to repeat the series of the steps in the drying process.

### Modification of First Embodiment

In the above-described the image forming apparatus 1 as illustrated in FIG. 8, if a detected humidity exceeds a humidity threshold value even in spite of operation of the exhaust fan 45 for a prescribed time, all of the airflow fan 44, the exhaust fan 45, and the duct fan 46 are operated. Herein, the exhaust fan 45 discharges the air inside the housing 41 from the exhaust opening 41a to the inside of the room RM. In a case in which not only the room RM is small but also a humidity inside the housing 41 is high, a humidity of the room RM may rise.

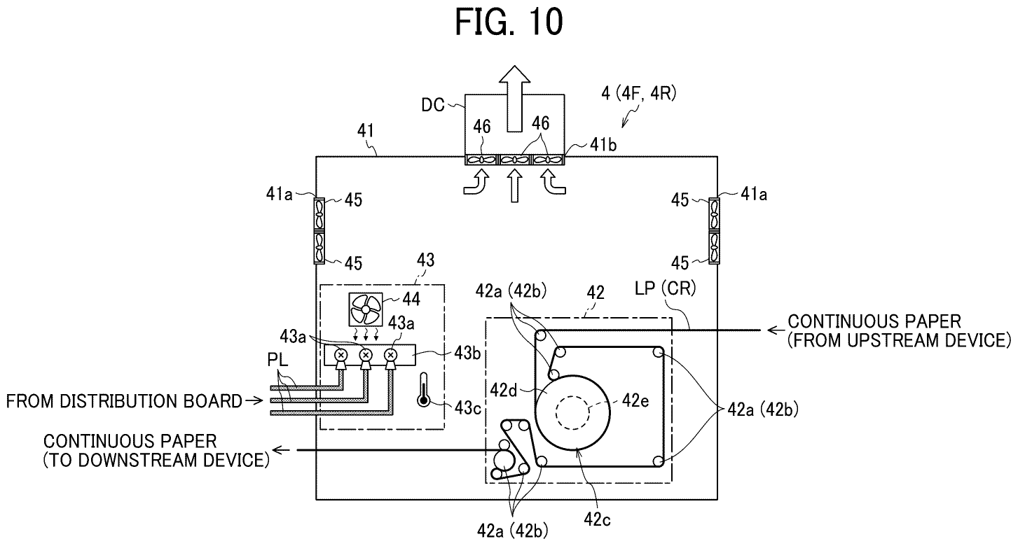

FIG. 10 illustrates a modification of the first embodiment, and is a schematic diagram illustrating a state in which an airflow fan 44 and a duct fan 46 are operated and an exhaust fan 45 is stopped in a drying unit 4. In the modification illustrated in FIG. 10, if a detected humidity exceeds a humidity threshold value in spite of operation of the exhaust fan 45 for a prescribed time (a second prescribe time), the airflow fan 44 and the duct fan 46 are operated and the exhaust fan 45 is stopped. Such control reduces an amount of the air to be discharged toward a room RM from a housing 41 when the duct fan 46 is operated, thereby reducing an unfavorable situation in which a humidity inside the room RM rises.

### Example of Control

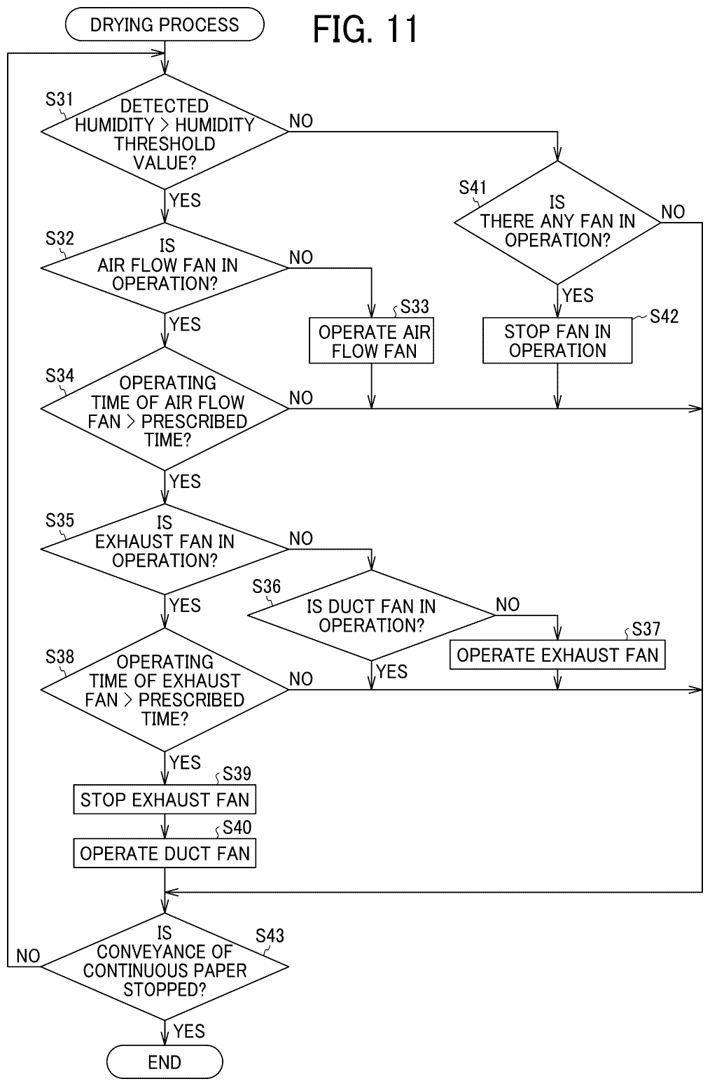

FIG. 11 is a flowchart illustrating control performed by the controller 9 in the modification, that is, FIG. 11 is a flowchart illustrating other control performed by the controller 9 in each of the drying processes in Steps S3 and S6 illustrated in FIG. 4. Hereinafter, the control performed by the controller 9 is described with reference to the flowchart illustrated in FIG. 11. In the description of the control in the modification, a process that is similar to that in the above-described control may be appropriately omitted. In step S31, the controller 9 determines whether a detected humidity exceeds a humidity threshold value. If the detected humidity exceeds the humidity threshold value (YES in step S31), the process proceeds to step S32. In step S32, the controller 9 determines whether the airflow fan 44 is in operation. If the airflow fan 44 is not in operation (NO in step S32), the process proceeds to step S33. In step S33, the controller 9 operates the airflow fan 44.

If the airflow fan 44 is in operation (YES in step S32), the process proceeds to step S34. In step S34, the controller 9 determines whether an operating time of the airflow fan 44 exceeds a prescribed time (a first prescribed time). If the operating time of the airflow fan 44 exceeds the prescribed time (YES in step S34), the process proceeds to step S35. In step S35, the controller 9 determines whether the exhaust fan 45 is in operation. If the exhaust fan 45 is not in operation (NO in step S35), the process proceeds to step S36. In step S36, the controller 9 determines whether the duct fan 46 is in operation. If the duct fan 46 is not in operation (NO in step S36), the process proceeds to step S37. In step S37, the controller 9 operates the exhaust fan 45. That is, in the modification, if the duct fan 46 is in operation (YES in step S36), the process differs from the aforementioned control in that the exhaust fan 45 is not operated. If the exhaust fan 45 is in operation (YES in step S35), the process proceeds to step S38. In step S38, the controller 9 determines whether an operating time of the exhaust fan 45 exceeds a prescribed time (a second prescribed time). If the operating time of the exhaust fan 45 exceeds the prescribed time (YES in step S38), the process proceeds to step S39. In step S39, the controller 9 stops the exhaust fan 45. Subsequently, in step S40, the controller 9 operates the duct fan 46.

If the detected humidity does not exceed the humidity threshold value (NO in step S31), the process proceeds to step S41. In step S41, the controller 9 determines whether there is a fan in operation. If there is a fan in operation (YES in step S41), the process proceeds to step S42. In step S42, the controller 9 stops the fan in operation. In step S43, the controller 9 determines whether the conveyance of the continuous paper LP is stopped. If the conveyance of the continuous paper LP is stopped (YES in step S43), a series of steps in the drying process ends. If the conveyance of the continuous paper LP is not stopped (NO in step S43), the process proceeds to step S31 to repeat the series of the steps.

### Second Embodiment

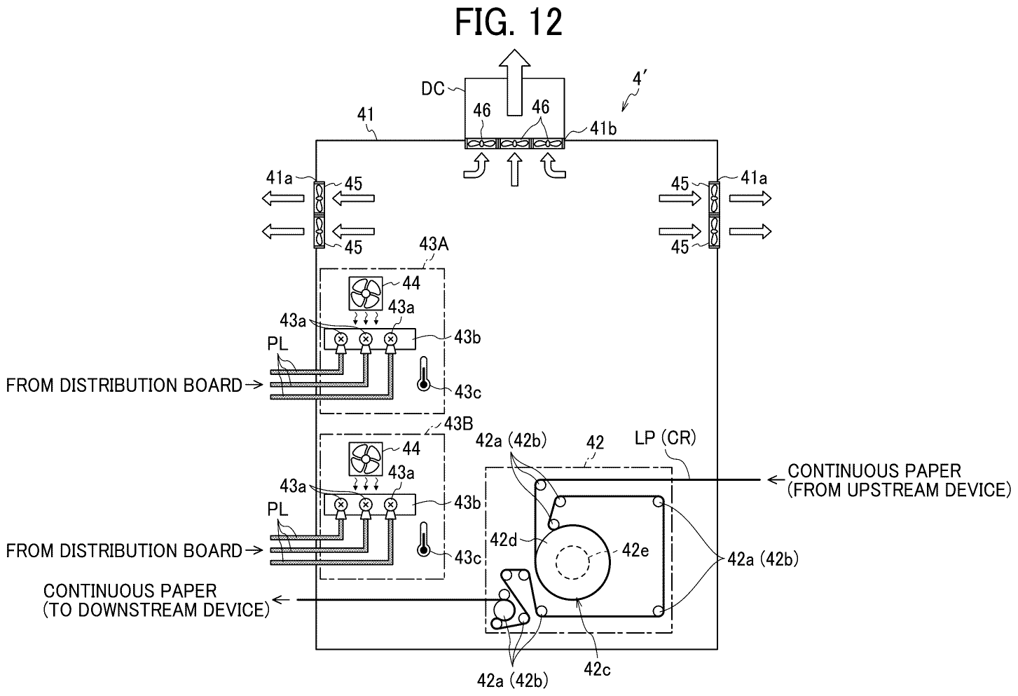

The first embodiment has been described using an example in which one electrical unit 43 is disposed in the drying unit 4 (each of the pre-processing drying unit 4F and the post-processing drying unit 4R). However, a plurality of electrical units 43 may be disposed. FIG. 12 is a schematic diagram illustrating a configuration of a drying unit 4′ according to the second embodiment. The drying unit 4′ illustrated in FIG. 12 includes a first electrical unit 43A and a second electrical unit 43B. Since the other components in the drying unit 4′ are similar to those in the drying unit 4 described above with reference to FIG. 2, descriptions thereof are omitted.

The first electrical unit 43A and the second electrical unit 43B have the same configuration. Each of the first electrical unit 43A and the second electrical unit 43B includes a terminal board 43b on which a plurality of connection terminals 43a is arranged, a humidity sensor 43c that detects a humidity inside a housing 41, and an airflow fan 44 that moves the air inside the housing 41 such that an airflow passing the connection terminal 43a is generated. That is, the drying unit 4′ of an image forming apparatus 1 according to the second embodiment includes a plurality of terminal boards 43b each including a plurality of connection terminals 43a. The airflow fan 44 and the humidity sensor 43c are disposed with respect to the plurality of terminal boards 43b. That is, a plurality of airflow fans 44 and the humidity sensors 43c are disposed. The plurality of connection terminals 43a on each of the terminal boards 43b is connected to respective lines PL that are for a heat roller 42c and routed from an outside of the housing 41. A detection signal from the humidity sensor 43c in the first electrical unit 43A and a detection signal from the humidity sensor 43c in the second electrical unit 43B are input to the controller 9, and the controller 9 controls the airflow fans 44 based on the respective detection signals (detected humidities). Even with the configurations according to the second embodiment, an advantage similar to the advantage obtained by the first embodiment can be obtained.

### Third Embodiment

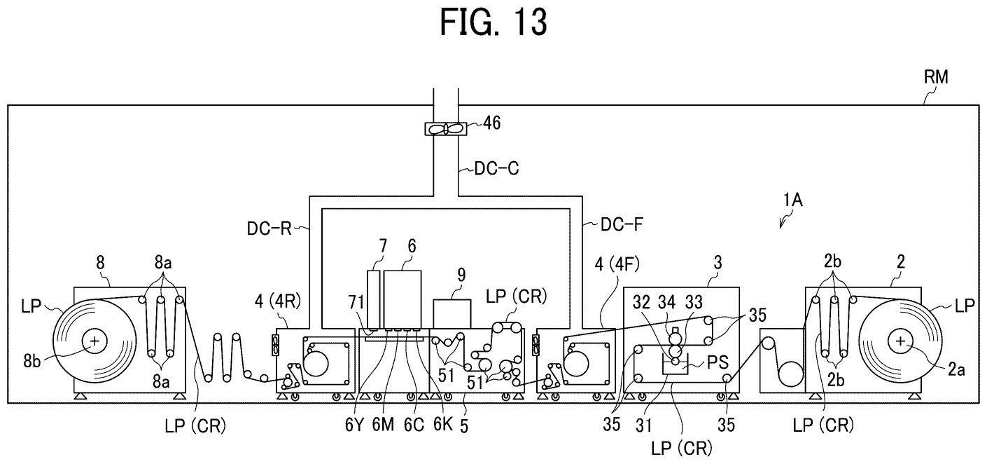

The first embodiment has been described using an example in which the exhaust ducts DC are separately connected to the pre-processing drying unit 4F and the post-processing drying unit 4R, and the duct fans 46 are arranged in the connection openings 41b of the housings 41 of the respective drying units 4F and 4R. However, the configuration is not limited thereto. FIG. 13 is a schematic diagram illustrating a configuration in which a duct fan 46 is disposed in a common exhaust duct DC-C according to a third embodiment. Components and configurations similar to those in the first embodiment are given the same reference codes as above and descriptions thereof are omitted. An image forming apparatus 1A illustrated in FIG. 13 corresponds to a dying system according to one embodiment of the present disclosure. An exhaust duct DC-F (a first exhaust duct) has an upstream end connected to a connection opening 41b of a pre-processing drying unit 4F (a first drying device, and an exhaust duct DC-R (a second exhaust duct) has an upstream end connected to a connection opening 41b of a post-processing drying unit 4R (a second drying device). A downstream end of the exhaust duct DC-F and a downstream end of the exhaust duct DC-R communicate with an upstream end of the common exhaust duct DC-C. The common exhaust duct DC-C includes a duct fan 46.

In the image forming apparatus 1A according to the third embodiment, since the duct fan 46 is arranged in the common exhaust duct DC-C, the number of the duct fans 46 in the image forming apparatus 1A can be smaller than that in the image forming apparatus 1 according to the first embodiment, and a configuration of the image forming apparatus 1A can be simpler than that of the image forming apparatus 1. In addition, in a case where a detected humidity inside a housing 41 in one of the pre-processing drying unit 4F and the post-processing drying unit 4R exceeds a humidity threshold value and the duct fan 46 is operated, such an operation of the duct fan 46 enables the air inside a housing 41 in the other one of the pre-processing drying unit 4F and the post-processing drying unit 4R to be also discharged, and thus a humidity inside such a housing 41 can be lowered.

### Fourth Embodiment

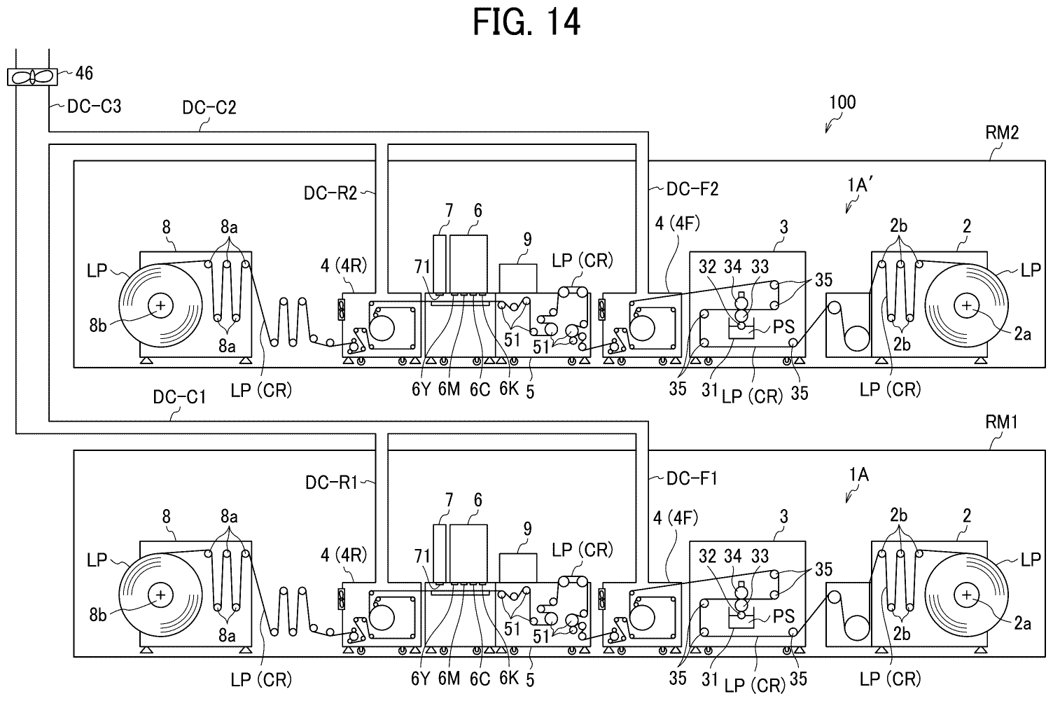

The third embodiment has been described using an example of the image forming apparatus 1A in which the exhaust duct DC-F of the pre-processing drying unit 4F and the exhaust duct DC-R of the post-processing drying unit 4R are connected to the common exhaust duct DC-C, and the duct fan 46 is disposed in the common exhaust duct DC-C. However, the configuration is not limited thereto. A fourth embodiment is described with reference to FIG. 14 that is a schematic diagram illustrating a configuration in which a duct fan 46 is disposed in a third common exhaust duct DC-C3. Components and configurations similar to those in the first embodiment are given the same reference codes as above and descriptions thereof are omitted. An image forming system 100 illustrated in FIG. 14 incudes a first image forming apparatus 1A placed in a first room RM1 and a second image forming apparatus 1A′ placed in a second room RM2.

In the image forming system 100 illustrated in FIG. 14, a downstream end of an exhaust duct DC-F1 of a pre-processing drying unit 4F disposed in the image forming apparatus 1A and a downstream end of an exhaust duct DC-R1 of a post-processing drying unit 4R disposed in the image forming apparatus 1A are connected to an upstream end of a first common exhaust duct DC-C1. Also, a downstream end of an exhaust duct DC-F2 of a pre-processing drying unit 4F disposed in the second image forming apparatus 1A′ and a downstream end of an exhaust duct DC-R2 of a post-processing drying unit 4R disposed in the second image forming apparatus 1A′ are connected to an upstream end of a second common exhaust duct DC-C2. In addition, a downstream end of the first common exhaust duct DC-C1 and a downstream end of the second common exhaust duct DC-C2 are connected to an upstream end of the third common exhaust duct DC-C3, and the duct fan 46 is disposed in the third common exhaust duct DC-C3. The duct fan 46 is controlled by each of a controller 9 in the image forming apparatus 1A and a controller 9 in the second image forming apparatus 1A′.

In the image forming system 100 according to the fourth embodiment, since the duct fan 46 is disposed in the third common exhaust duct DC-C3, a configuration of the image forming system 100 can be simpler than a configuration of an image forming system in which duct fans 46 are disposed in respective connection openings 41b of four drying units 4 (a pre-processing drying unit 4F and a post-processing drying unit 4R disposed in an image forming apparatus 1A, and a pre-processing drying unit 4F and a post-processing drying unit 4R disposed in a second image forming apparatus 1A′). Moreover, if a detected humidity inside a housing 41 of any one of the four drying units 4 exceeds a humidity threshold value and the duct fan 46 is operated, the air inside housings 41 of the rest of three drying units 4 is also discharged, and thus humidities inside such housings 41 can be lowered.

### Other Modifications

Each of the embodiments has been described using an example in which only the airflow fan 44 is operated if a detected humidity exceeds a humidity threshold value in a state in which three types of fans (the airflow fan 44, the exhaust fan 45, and the duct fan 46) are stopped, the exhaust fan 45 is operated if a detected humidity exceeds the humidity threshold value in spite of operation of the airflow fan 44 for a first prescribed time, and the duct fan 46 is operated if a detected humidity exceeds the humidity threshold value even in spite of operation of the exhaust fan 45 for a second prescribed time. However, the configuration of each of the embodiments is not limited thereto. Each of the above-described embodiments can be applied to, for example, a configuration in which operations (operation and stop) of the airflow fan 44, the exhaust fan 45, and the duct fan 46 are controlled based on a detected humidity.

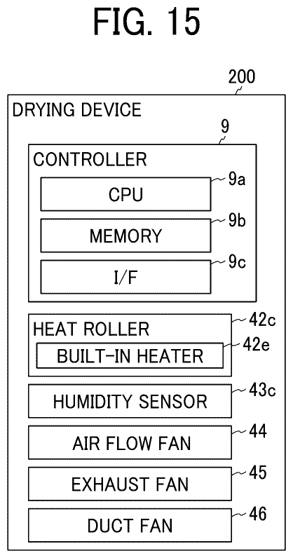

The embodiments of the present disclosure have been described using examples in which the image forming apparatuses 1, 1A, and 1A′ each include a drying device. However, the present disclosure is not limited to such embodiments. For example, a drying device can be separated from the image forming apparatus 1, 1A, or 1A′ so that the drying device is independently operable. FIG. 15 is a block diagram illustrating a configuration of a drying device 200 that is independently operable. The drying device 200 illustrated in FIG. 15 has a configuration in which a controller 9 (including a CPU 9a, a memory 9b, and an I/F 9c) is disposed with respect to the drying unit 4 described with reference to FIG. 2. The drying device 200 can be operated with cooperation with an image forming apparatus 1 or operated independently from the image forming apparatus 1.

The embodiments have been described using examples in which the image forming apparatuses 1, 1A, and 1A′ each include both of the pre-processing drying unit 4F and the post-processing drying unit 4R. However, the present disclosure can be applied to an image forming apparatus including one of the pre-processing drying unit 4F and the post-processing drying unit 4R. Although the embodiments of the present disclosure have been described using examples of the inkjet image forming apparatuses 1, 1A, and 1A′, the embodiments are not limited thereto. For example, the present disclosure can even be applied to an image forming apparatus employing another method such as an electrophotographic method. The controller 9 can partially or entirely function using hardware logic. The humidity sensor 43c can be disposed in a place other than the electrical unit 43 as long as a humidity inside the housing 41 can be detected. The plurality of connection terminals 43a has been described using an example of terminals to which the lines PL for the heat roller 42c are connected. However, the connection terminals 43a can be terminals to which lines for other uses are connected.

The embodiments have been described using examples in which the image forming apparatuses 1, 1A, and 1A′ each form an image on continuous paper LP (a recording medium). However, the present disclosure is not limited to such embodiments. For example, the present disclosure can even be applied to an image forming that forms an image on flat paper (a recording medium). The recording medium can be matter that retains liquid (e.g., various solvents including water) and releases the retained liquid when heated from outside. Examples of the recording medium can include a post card, an envelope, a coated sheet (e.g., coated paper and art paper), tracing paper, an overhead projector (OHP) sheet, an OHP film, and a prepreg.

### Advantages of Embodiments of Present Disclosure

### First Aspect

A drying device (e.g., a pair of a drying unit 4 and a controller 9, a pair of a drying unit 4′ and a controller 9, and a drying device 200) includes a housing 41, a conveyance unit 42b (a conveyor), a heat roller 42c (a heater), a connection terminal 43a, a humidity sensor 43c (a humidity detector), an airflow fan 44, an exhaust fan 45, a duct fan 46, and a controller 9 (circuitry). In the housing 41, an exhaust opening 41a and a connection opening 41b are arranged. The conveyance unit 42b is housed in the housing 41 and conveys continuous paper LP (a recording medium) along a conveyance path CR. The heat roller 42c is housed in the housing 41 and heats the continuous paper LP on the conveyance path CR. The connection terminal 43a connects a line PL routed from the outside of the housing 41. The line is connected inside the housing. The humidity sensor 43c detects a humidity inside the housing 41. The airflow fan 44 moves the air inside the housing 41 such that an airflow passing the connection terminal 43a is generated. The exhaust fan 45 discharges the air inside the housing 41 to the outside of the housing 41 via the exhaust opening 41a. The duct fan 46 discharges the air inside the housing 41 via an exhaust duct DC connected to the connection opening 41b. The controller 9 controls operations of the airflow fan 44, the exhaust fan 45, and the duct fan 46 based on a detected humidity that is detected by the humidity sensor 43c.

Image forming apparatuses include an industrial image forming apparatus in addition to a consumer image forming apparatus. The industrial image forming apparatus represents, for example, an image forming apparatus used in manufacture of printed matter. In general, an amount of image formation per unit time of the industrial image forming apparatus is greater than that of the consumer image forming apparatus, and an amount of liquid evaporating from a recording medium by the industrial image forming apparatus is greater than that by the consumer image forming apparatus. A humidity inside a housing disposed in the industrial image forming apparatus tends to rise more easily than that in the consumer image forming apparatus. To manage a humidity inside the housing in the industrial image forming apparatus, enhancement of dischargeability of the image forming apparatus to discharge the air inside the housing can be effective. However, an increase in the number of fans alone or the use of a larger fan having high dischargeability alone is not desirable as more operating noise is generated or more power is consumed.

According to the drying device with the first aspect, since the controller 9 controls operations of the airflow fan 44, the exhaust fan 45, and the duct fan 46 based on a humidity detected by the humidity sensor 43c, an airflow passing the connection terminal 43a can be generated inside the housing 41, and a discharge destination of the air inside the housing 41 can be selected from either the outside of the housing 41 or the exhaust duct DC. As a result, a humidity inside the housing 41 can be appropriately managed.

### Second Aspect

In the drying device (e.g., a pair of a drying unit 4 and a controller 9, a pair of a drying unit 4′ and a controller 9, and a drying device 200) with the first aspect, the humidity sensor 43c is disposed in an electrical unit 43 to detect a humidity in the vicinity of the connection terminal 43a. Moreover, the controller 9 operates only the airflow fan 44 if a detected humidity exceeds a humidity threshold value in a state in which the airflow fan 44, the exhaust fan 45, and the duct fan 46 are stopped. The controller 9 operates the exhaust fan 45 if the detected humidity exceeds the humidity threshold value even in spite of operation the airflow fan 44 for a first prescribed time. The controller 9 operates the duct fan 46 if the detected humidity exceeds the humidity threshold value even in spite of operation of the exhaust fan 45 for a second prescribed time.

According to the drying device with the second aspect, therefore, since the controller 9 operates the airflow fan 44, the exhaust fan 45, and the duct fan 46 in this order in a stepwise manner, an operating ratio of the airflow fan 44 can be increased, and an operating ratio of the duct fan 46 can be reduced. As a result, power consumption and operating noise can be suppressed.

### Third Aspect

In the drying device (e.g., a pair of a drying unit 4 and a controller 9, a pair of a drying unit 4′ and a controller 9, and a drying device 200) with the second aspect, the controller 9 stops the exhaust fan 45 and operates the duct fan 46 if a detected humidity exceeds the humidity threshold value even in spite of operation of the exhaust fan 45 for the second prescribed time. According to the drying device with the third aspect, the exhaust fan 45 is stopped while the duct fan 46 is being operated, thereby reducing an unfavorable situation in which a humidity inside a room RM rises.

### Fourth Aspect

In the drying device (e.g., a pair of a drying unit 4 and a controller 9, a pair of a drying unit 4′ and a controller 9, and a drying device 200) with the first aspect, the drying device further includes a plurality of terminal boards 43b each including a plurality of connection terminals 43a including the aforementioned connection terminal 43a, a plurality of airflow fans 44 including the aforementioned airflow fan 44, and a plurality of humidity sensors 43c including the aforementioned humidity sensor 43c. The plurality of the airflow fans 44 and the plurality of humidity sensors 43c are disposed to correspond to the plurality of terminal boards 43b. The controller 9 controls the plurality of airflow fans 44 based on detection signals from the plurality of humidity sensor 43c. According to the drying device with the fourth aspect, therefore, a humidity inside the housing 41 can be appropriately managed.

### Fifth Aspect

A drying system (an image forming apparatus 1A) includes a first drying device (a pair of a pre-processing drying unit 4F and a controller 9) and a second drying device (a pair of a post-processing drying unit 4R and the controller 9). The pair the pre-processing drying unit 4F and the controller 9, and the pair of the post-processing drying unit 4R and the controller 9 are configured as described in each of the above aspects. Moreover, each of a downstream end of an exhaust duct DC-F (a first exhaust duct) having an upstream end connected to a connection opening 41b of the pre-processing drying unit 4F, and a downstream end of an exhaust duct DC-R (a second exhaust duct) having an upstream end connected to a connection opening 41b of the post-processing drying unit 4R (a second drying device) communicates with an upstream end of a common exhaust duct DC-C, and a duct fan 46 is disposed in the common exhaust duct DC-C. According to the drying system with the fifth aspect, the number of duct fans 46 can be reduced, so that a configuration can be simplified. In addition, in a case where a detected humidity inside a housing 41 in one of the pre-processing drying unit 4F and the post-processing drying unit 4R exceeds a humidity threshold value and the duct fan 46 is operated, such an operation of the duct fan 46 enables the air inside a housing 41 in the other one of the pre-processing drying unit 4F and the post-processing drying unit 4R to be also discharged, and thus a humidity inside the housing 41 can be lowered.

### Sixth Aspect

An image forming apparatus (e.g., each of image forming apparatuses 1 and 1A) includes an image forming unit 6 (an image forming device) that forms an image on continuous paper LP (a recording medium), and the pair of the drying unit 4 and the controller 9 (the drying device) or the pair of the drying unit 4′ and the controller 9 (the drying device) that are described in each of the above aspects. According to the image forming apparatus with the sixth aspect, a humidity inside the housing 41 can be appropriately managed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A drying device, comprising:
a housing in which an exhaust opening and a connection opening are arranged;
a conveyor housed in the housing to convey a recording medium along a conveyance path;
a heater housed in the housing to heat the recording medium on the conveyance path;
a connection terminal to connect a line routed from an outside of the housing, the line being connected to the connection terminal inside the housing;
a humidity sensor to detect a humidity inside the housing;
an airflow fan to move air inside the housing to generate an airflow passing the connection terminal;
an exhaust fan to discharge air inside the housing to an outside of the housing through the exhaust opening;
a duct fan to discharge air inside the housing through an exhaust duct connected to the connection opening; and
processing circuitry configured to control operations of the airflow fan, the exhaust fan, and the duct fan based on a detected humidity that is detected by the humidity sensor.

2. The drying device according to claim 1,
wherein the humidity sensor is disposed to detect a humidity in a vicinity of the connection terminal, and
wherein the processing circuitry is configured to:
operate only the airflow fan among the airflow fan, the exhaust fan, and the duct fan, when the detected humidity exceeds a threshold value in a state in which the airflow fan, the exhaust fan, and the duct fan are stopped;
operate the exhaust fan, when the detected humidity exceeds the threshold value after the airflow fan is operated for a first prescribed time; and
operate the duct fan, when the detected humidity exceeds the threshold value after the exhaust fan is operated for a second prescribed time.

3. The drying device according to claim 2,
wherein the processing circuitry is configured to stop the exhaust fan and operate the duct fan, when the detected humidity exceeds the threshold value after the exhaust fan is operated for the second prescribed time.

4. The drying device according to claim 1, further comprising:
a plurality of terminal boards, each of which includes a plurality of connection terminals including the connection terminal;
a plurality of airflow fans, including the airflow fan, disposed in one-to-one correspondence with the plurality of terminal boards; and
a plurality of humidity sensors, including the humidity sensor, disposed in one-to-one correspondence with the plurality of terminal boards,
wherein the processing circuitry is configured to control the plurality of airflow fans based on detection signals from the plurality of humidity sensors.

5. A drying system, comprising:
a first drying device and a second drying device, each of the first drying device and the second drying device including
a housing in which an exhaust opening and a connection opening are arranged,
a conveyor housed in the housing to convey a recording medium along a conveyance path,
a heater housed in the housing to heat the recording medium on the conveyance path,
a connection terminal to connect a line routed from an outside of the housing, the line being connected to the connection terminal inside the housing,
a humidity sensor to detect a humidity inside the housing,
an airflow fan to move air inside the housing to generate an airflow passing the connection terminal, and
an exhaust fan to discharge air inside the housing to an outside of the housing through the exhaust opening;
a duct fan to discharge air inside the housing;
processing circuitry configured to
control operations of the airflow fan and the exhaust fan of the first drying device and the duct fan based on a detected humidity that is detected by the humidity sensor of the first drying device, and
control operations of the airflow fan and the exhaust fan of the second drying device and the duct fan based on a detected humidity that is detected by the humidity sensor of the second drying device;
a first exhaust duct having an upstream end connected to the connection opening of the first drying device;
a second exhaust duct having an upstream end connected to the connection opening of the second drying device; and
a common exhaust duct having an upstream end communicating with each of a downstream end of the first exhaust duct and a downstream end of the second exhaust duct, the duct fan disposed in the common exhaust duct.

6. An image forming apparatus comprising:
an image forming device to form an image on a recording medium; and
the drying device according to claim 1.
